(19) United States
(12) Patent Application Publication
(10) Pub. No.: US 2009/0285162 A1
(43) Pub. Date: Nov. 19, 2009

(54) METHOD, SYSTEM AND TERMINAL FOR LOCATING

(76) Inventors: Yong XIE, Shenzhen (CN); Wenliang Liang, Shenzhen (CH); Hong Li, Shenzhen (CN); Jianyong Li, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/508,658

(22) Filed: Jul. 24, 2009

Related U.S. Application Data
(63) Continuation of application No. PCT/CN2008/070019, filed on Jan. 4, 2008.

(30) Foreign Application Priority Data
Jan. 26, 2007 (CN) 200710073066.3

(51) Int. Cl. H04W 4/02

(52) U.S. Cl. 370/328; 455/456.2

(57) ABSTRACT

A locating method is provided. The serving ASN-GW sends locating measurement information to a WiMAX terminal; the WiMAX terminal measures the locating data, and sends the locating data measurement result to the entity capable of calculating locating information; and the entity capable of calculating locating information calculates the locating information according to the locating data measurement result. A locating system, a locating data measurement entity, an LCF, and a calculation entity are also disclosed herein. The provided method, system and entity may provide a Locating Service (LCS) for the users in a WiMAX network.

### CROSS-REFERENCE TO RELATED APPLICATIONS

This application is a continuation of International Application No. PCT/CN2008/070019, filed on Jan. 4, 2008, which claims priority to Chinese Patent Application No. 200710073066.3, filed on Jan. 26, 2007. The contents of both applications are hereby incorporated by reference in their entirety.

### TECHNICAL FIELD

The present disclosure relates to locating technologies, and in particular, to a method, system and terminal for locating in a Worldwide Interoperability for Microwave Access (WiMAX) network.

### BACKGROUND

The WiMAX is a Wireless Metropolitan Area Network (WMAN) technology based on the Institute of Electrical and Electronics Engineers (IEEE) 802.16 d/e standard. The IEEE 802.16 d (802.16-2004) standard is primarily applicable to the non Line Of Sight (LOS) point-to-multipoint technology in a Metropolitan Area Network (MAN). Its standard working band is 2 GHz-11 GHz, which is a hybrid band that combines authorized frequencies and unauthorized frequencies and can prevent multi-path fading effectively. In the case of the best channel fading, the transmission rate approaches 75 Mbps. The simple mobile communication technology will be added into the IEEE 802.16 e under discussion.

FIG. 1 shows the components of a WiMAX network. As shown in FIG. 1, the network includes: a Mobile Station (MS) or Subscriber Station (SS), an Access Service Network (ASN), and a Connection Service Network (CSN). The ASN includes a Base Station (BS) and an ASN Gateway (ASN-GW). The CSN includes a Pre-Paid Service (PPS) server and an Authentication, Authorization Accounting (AAA) server.

The MS/SS is a WiMAX terminal, which is responsible for user access to the WiMAX network.

The ASN is a collection of network functions that provide radio access services for the WiMAX terminal. The ASN is responsible for: ensuring creation of layer-2 (L2) connection between the WiMAX terminal and the WiMAX BS, managing radio resources, performing network discovery, selecting the best service provider of the WiMAX subscriber network, acting as an agent server in the agent mobile IP mode to control the authentication authorization accounting messages of the WiMAX user, and providing a relay for creating the layer-3 (L3) application connection of the WiMAX terminal.

The ASN includes a BS and an ASN-GW, where the BS is adapted to provide L2 connection with the MS/SS, and implement radio resource management. The ASN-GW is adapted to provide a client for the authentication, authorization and accounting of the MS/SS, and provide L3 information delay for the MS/SS, for example, IP address allocation and ASN inscribing.

The CSN is responsible for allocating IP addresses to the WiMAX user session, providing Internet access, acting as an AAA agent server or AAA server, performing policy and access control based on subscription data, supporting creation of a tunnel between the ASN and the CSN, supporting generation of WiMAX subscriber bills and trans-operator WiMAX service settlement, supporting creation of a tunnel between CSNs, supporting mobility between ASNs, and supporting multiple WiMAX services, for example, Location Based Service (LBS), end-to-end service, multimedia broadcast, and multicast service.

The LBS is a Value-Added Service (VAS) that obtains the location information (such as longitude and latitude coordinates) of a mobile terminal user through a mobile network and provides an LCS for the user through support of an electronic map. Currently, various mobile terminals such as mobile phones are used extensively, increasing the significance of the LBS. After activating the LBS, the user can know their current location and query the mobile terminal about the nearby locale (i.e. where I am, where the nearest hospital is, which banks are around me, how I can travel to a place from here, where my friends are currently located, etc.). The LBS is also applicable to emergency aid, tracking senior citizens, motorcade management, etc. In summary, the LBS is capable of sending the right location information to the right person at the right time and place.

Because the LBS provides the foregoing functions, the WiMAX network based on the mobile broadband MAN technology is expected to provide support of the locating technology for users. The locating technology involves the issue of locating accuracy, namely, the Quality of Service (QoS) of the LCS, including:

(1) horizontal accuracy: represented by longitude and latitude and the corresponding error rate;

(2) vertical accuracy: represented by height, namely, absolute height and relative height;

(3) velocity and direction: indicative of the motion speed and direction of the located object; and

(4) response time: specifies the locating response time of the system.

With respect to implementing the LBS technology, the locating method of a general wireless cellular system is categorized into: locating method based on external signals, and locating method based on the signals of the radio system. For example, the Global Positioning System (GPS) is based on external signals, where the network can send some GPS satellite information as a support in order to speed up the locating process and improve the locating accuracy; the Base Station Identifier (BSID) and radio signal Round Trip Delay (RTD) locating methods are based on the signals of the radio system. Many other locating methods in addition to those mentioned above are in practice. However, no explicit solution is available in the prior art as regards how to implement locating in a WiMAX network.

### SUMMARY

Embodiments consistent with the present disclosure is provide a locating method which provides a location service (LCS) for users in a WiMAX network.

Some embodiments of the present disclosure is provide a locating system which provides an LCS for users in a WiMAX network.

Some embodiments of the present disclosure is provide a terminal which provides an LCS for users in a WiMAX network.

Accordingly, a locating method consistent with the disclosed embodiments is provided. The locating method comprises the following steps:

sending, by an LCF entity, a locating request, obtaining a locating data measurement result, and sending the locating data measurement result to an entity capable of calculating locating information; and

calculating, by the entity capable of calculating locating information, the locating information according to the locating data measurement result.

A locating system is also provided. The locating system comprises:

an LCF entity adapted to send a locating request to the locating data measurement entity, and receive the locating information from the calculation entity and output the locating information;

a locating data measurement entity adapted to receive the locating request from the LCF entity, perform locating data measurement according to the locating request, and send the obtained locating data measurement result to the calculation entity; and

a calculation entity adapted to receive the locating data measurement result from the locating data measurement entity, calculate the locating information according to the locating data measurement result, and send the locating information to the LCF entity.

A terminal is also provided. The terminal comprises:

a locating data measurement entity adapted to receive a locating request from a LCF entity, perform locating data measurement according to the locating request, and send an obtained locating data measurement result to a calculation entity; and

the calculation entity adapted to receive the locating data measurement result from the locating data measurement entity, calculate the locating information according to the locating data measurement result, and send the locating information to the LCF entity.

Therefore, through some embodiments of the present disclosure, a locating mechanism is introduced into the WiMAX network. The WiMAX terminal performs locating data measurement according to the locating request from the serving ASN-GW, and returns the locating data measurement result to the entity capable of calculating locating information in the network. The entity capable of calculating locating information obtains the location information of the WiMAX terminal through calculation of the locating data measurement result. The method is easily practicable and quickly responsive, and ensures precision and accuracy of locating.

### BRIEF DESCRIPTION OF THE DRAWINGS

FIG. 1 shows a structure of a WiMAX network in the prior art;

FIG. 2 is a flowchart of a locating method according to an embodiment of the present disclosure;

FIG. 3 shows how to locate a WiMAX terminal through multiple BSIDs in accordance with a locating method according to an embodiment of the present disclosure;

FIG. 4 shows how to locate a WiMAX terminal through multiple BS RTDs in accordance with a locating method according to an embodiment of the present disclosure;

FIG. 5 shows how to locate a WiMAX terminal through a hyperbola in accordance with a locating method according to an embodiment of the present disclosure;

FIG. 6 shows a structure of a locating method according to a first preferred embodiment of the present disclosure;

FIG. 7 is a flowchart of a locating method according to a second preferred embodiment of the present disclosure;

FIG. 8 is a flowchart of a locating method according to a third preferred embodiment of the present disclosure;

FIG. 9 shows a structure of a locating system according to the first preferred embodiment of the present disclosure; and

FIG. 10 shows a structure of a locating system according to the second preferred embodiment of the present disclosure.

### DETAILED DESCRIPTION

Certain embodiments of the present disclosure are detailed below by reference to accompanying drawings.

The locating method in an embodiment of the present disclosure includes the following steps:

Step 101: An LCF entity sends a locating request, obtains a locating data measurement result, and sends the locating data measurement result to an entity capable of calculating locating information.

Step 102: The entity capable of calculating locating information calculates the locating information according to the locating data measurement result.

The process of the LCF entity sending a locating request includes the following the following.

The serving ASN-GW sends locating measurement information to the WiMAX terminal.

Optionally, the serving ASN-GW sends locating measurement information to the serving BS (S-BS), and the S-BS sends the locating measurement information to the WiMAX terminal.

The step of obtaining the locating data measurement result is the locating data measurement process of the WiMAX terminal, which is detailed in the following embodiments. The specific implementation process of the present disclosure is described below by reference to accompanying drawings.

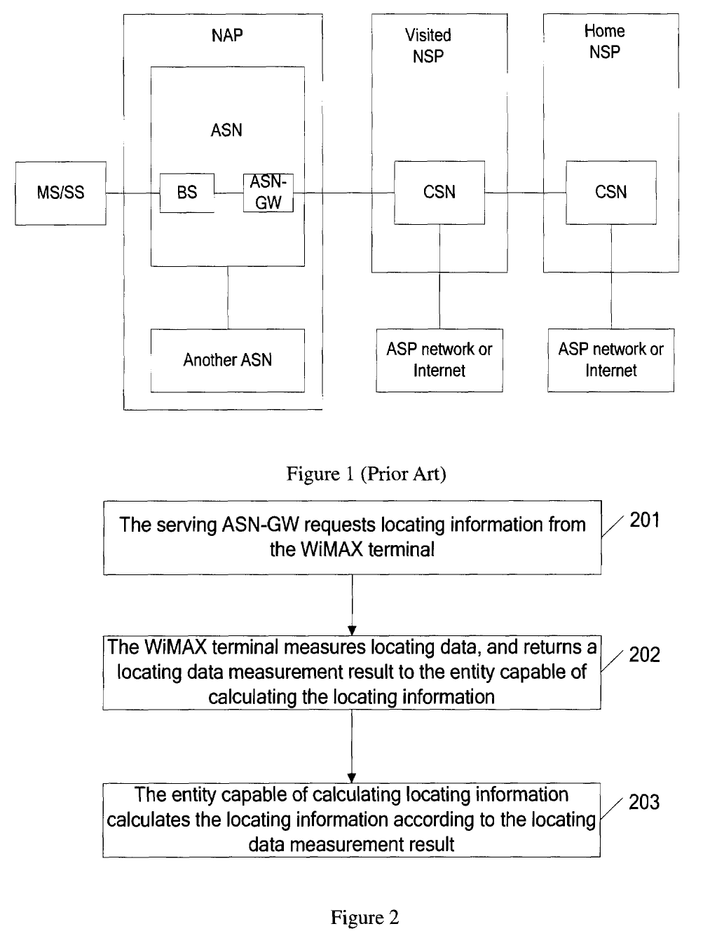

FIG. 2 is a flowchart of a method in an embodiment of the present disclosure. As shown in FIG. 2, the method includes the following steps:

Step 201: The LCF entity sends a locating request to the WiMAX terminal. The locating request specifies the data that need to be measured for the LCS. The data includes but is not limited to: radio RTD, Relative Delay (RD), serving BSID, neighboring cell BSID, Carrier-to-Interference and Noise Ratio (CINR), Received Signal Strength Indicator (RSSI), and radio signal measurement result of the neighboring cell BS (N-BS).

The CINR and the RSSI assist in analyzing the measurement signals, and enhance the precision of calculating the locating measurement result, if multiple N-BS signals exist.

The method for an LCF entity to send locating measurement information to the WiMAX terminal may be as follows:

In the case that the LCF entity is located in the ASN-GW:

sending, by a serving ASN-GW, locating measurement information to the WiMAX terminal; or

sending, by the serving ASN-GW, locating measurement information to the S-BS; and

sending, by the S-BS, the locating measurement information to the WiMAX terminal.

In the case that the LCF entity is independent of the ASN-GW:

sending, by the LCF entity, a locating request to the serving ASN-GW; and sending, by the serving ASN-GW, the locating measurement information to the WiMAX terminal; or

sending, by the LCF entity, a locating request to the serving ASN-GW; sending, by the serving ASN-GW, the locating measurement information to the S-BS; and sending, by the S-BS, the locating measurement information to the WiMAX terminal.

Step 202: The WiMAX terminal measures locating data, and sends a locating data measurement result to the entity capable of calculating the locating information.

The method for the WiMAX terminal to measure the locating data depends on the selected locating method, and falls in the following three scenarios:

(1) The multi-BSID locating mode is applied.

The WiMAX terminal measures the signal strength of the N-BS. If the signal strength reaches a preset threshold, the BSID of the N-BS is sent back to the serving ASN-GW. The BSID is the locating data measurement result, and the threshold may be a preset empirical value.

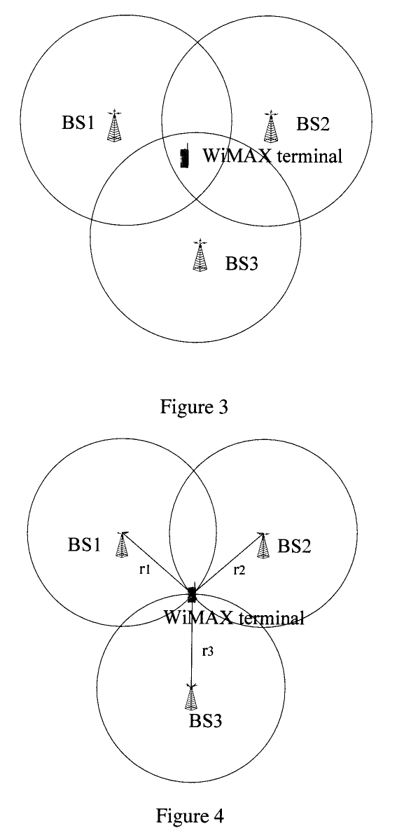

Because the locating method based on the BSID of the S-BS is not quite precise, in practice, multiple BSIDs are generally applied to WiMAX terminal locating. If the WiMAX terminal detects the signals of the N-BS successfully and the signal strength reaches a preset threshold, the WiMAX terminal records the BSID of the N-BS, uses each BSID to obtain the coverage area information of each BS, and works out the intersection of the coverage areas of all BSs. The intersection is the locating information. FIG. 3 shows how to locate a WiMAX terminal through multiple BSIDs. As shown in FIG. 3, supposing that BS1 is S-BS and BS2 and BS3 are two N-BSs, the intersection of three location areas is the location area of the WiMAX terminal.

If multiple BSIDs are obtained through measurement, the CINR and RSSI may be used to assist in analyzing the locating measurement result and enhance the precision of calculating the locating measurement result.

(2) The RTD method is applied.

The WiMAX terminal scans the S-BS and the N-BS to obtain the RTD value for a round trip between the WiMAX terminal, the S-BS, and the N-BS. The RTD value is the locating data measurement result.

The RTD represents the time required for a round-trip of a signal between the WiMAX terminal and the BS, and can be measured by the WiMAX terminal in the process of synchronization between the BS and the WiMAX terminal. The measurement result may be reported by the WiMAX terminal to the BS through a mobile scan report (MOB_SCN-REP).

The impact of the BS feeder length is considered in calculating the RTD. At the same time, the WiMAX terminal and the BS handle the signals (for example, modulate and demodulate the signals) to some extent when receiving or transmitting the signals. The handling occupies certain time, which is measurable at the WiMAX terminal and the BS respectively. Alternatively, prior knowledge is used to compensate for the time and reduce the measurement errors. The specific implementation is as follows:

Supposing that the time required for the WiMAX terminal to handle the signal is T_{MS}, the time required for the BS to handle the signal is T_{BS}, and the time of propagating the signal on the BS feeder is Tₐ, the Time Of Arrival (TOA) is calculated through the following formula:

$$TOA = \frac{1}{2} RTD - {T}_{a} - {T}_{MS } - {T}_{BS} .$$

Further, the distance between the WiMAX terminal and the BS is:

$$r = c \cdot ( \frac{1}{2} RTD - {T}_{a} - {T}_{MS} - {T}_{BS} ) ,$$

where c is a light velocity constant.

In order to locate a WiMAX terminal more precisely, it is appropriate to measure the RTD corresponding to each BS by reference to multiple BSs in the neighboring cell, and further locate the WiMAX terminal through the cross-location of each N-BS measurement area. FIG. 4 shows how to locate a WiMAX terminal through the RTD of multiple BSs. As shown in FIG. 4, supposing that BS1 is S-BS, BS2 and BS3 are N-BSs, and each BS forms a location area defined by a circle with each BS being a circle center and the corresponding RTD being a radius, the intersection location of the three location areas is the found location of the WiMAX terminal.

The RTD between the N-BS and the WiMAX terminal may be obtained by calculating the RD of the N-BS relative to the S-BS, where the RD is carried in the MOB_SCN-REP message:

Supposing that the S-BS is BS₁, the RTD between BS₁ and the WiMAX terminal is RTD₁, and the RD between BS₁ and the neighboring cell BSₙ is RDₙ, then:

(RTDₙ−RTD₁)/2=RDₙ, namely, RTDₙ=2RDn+RTD1.

It should be noted that the obtained intersection may be an area rather than a point due to measurement errors when multiple BSs are used to measure the RTD. In this case, in the locating of the WiMAX terminal, a proper area may be used as a locating result of the WiMAX terminal.

If multiple results of the RTD between the WiMAX terminal and the BS are obtained through measurement, the CINR and RSSI may be used to assist in analyzing the locating measurement result and enhance the precision of calculating the locating measurement result.

(3) The hyperbola locating method is applied.

The WiMAX terminal scans the S-BS and two or more N-BSs, and obtains the time difference (RD) value of the downlink signal transmitted between the S-BS and the N-BS. In order to further improve the locating accuracy, the WiMAX terminal may further scan the S-BS and two or more N-BSs, and obtain the RTD value between the WiMAX terminal, the S-BS, and the N-BS. RD and RTD values are the locating data measurement results.

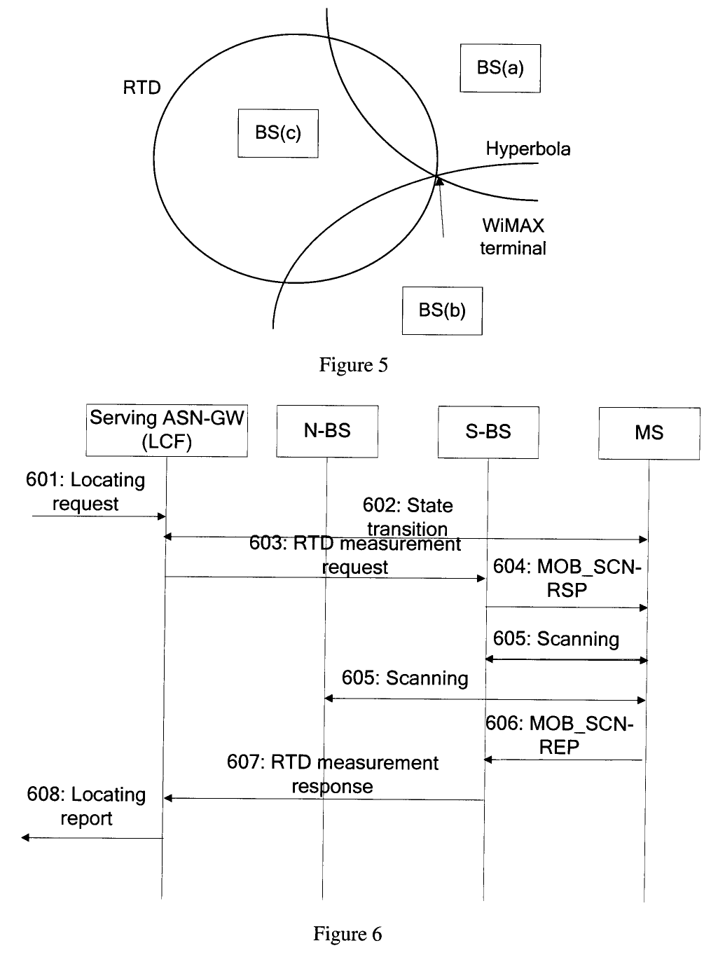

The hyperbola locating principles are: Two BSs are selected in the system; a hyperbola is formed by the points where the distance difference between the WiMAX terminal, the S-BS, and the N-BS is a fixed value; another hyperbola is formed in the same way; and the intersection of the two hyperbolas is the found location. FIG. 5 shows how to locate a WiMAX terminal through hyperbolas. As shown in FIG. 5, two hyperbolas are obtained by using BS(a) and BS(b) and using BS(a) and BS(c). The intersection of the two hyperbolas is the location of the WiMAX terminal. On this basis, in order to improve the locating precision, the RTD between the WiMAX terminal and the BS may be measured so that more information is available to estimate the location of the mobile station. If multiple results of the RTD between the WiMAX terminal and the BS are obtained through measurement, the CINR and the RSSI may be used to assist in analyzing the locating measurement result and to enhance the precision of calculating the locating measurement result.

Evidently, the hyperbola locating method may require that the WiMAX terminal must be able to measure the signals and synchronize the signals to at least three BSs.

In the hyperbola locating method, when the WiMAX terminal scans the N-BS, the WiMAX terminal scans the specified N-BS according to the locating scan indication, if the locating measurement information carries a locating scan indication; otherwise, the WiMAX terminal selects an N-BS for scanning according to the strength of each received N-BS signal, where the selected N-BS is an N-BS whose signal strength reaches a preset threshold. Before the WiMAX scans the N-BS, association may be performed between the N-BSs.

Step 203: The entity capable of calculating locating information calculates the locating information according to the locating data measurement result.

In this step, depending on the locating mode in use, the entity capable of calculating locating information calculates the locating information in the following methods.

If the locating method based on multiple BSIDs is applied, the entity capable of calculating locating information calculates the intersection of the coverage areas of all BSs. The intersection is the locating information, namely, found location.

If the RTD-based locating method is applied, the entity capable of calculating locating information calculates the intersection of the location areas defined by the RTD values. The intersection is the locating information.

If the hyperbola-based locating method is applied, the entity capable of calculating locating information calculates the intersection of the hyperbolas defined by the RD values. The intersection is the locating information.

The entity capable of calculating locating information may be a serving ASN-GW, or WiMAX terminal, or S-BS, or other network entity capable of calculating. When different entities capable of calculating locating information are applied, the implementation process of the present disclosure is the same except that the entity for calculating the locating information is different.

Before the foregoing method is implemented, the serving ASN-GW receives the locating request message from the CSN or LCS server. The locating request message includes but is not limited to the following contents: identifier of the locating request sender, identifier of the located terminal, locating type, time of sending the locating request, locating method, requested QoS parameters (for example, locating precision, response time, and requested locating QoS level) of the LCS, mode of reporting the locating result, and periodical locating information (frequency, count or total time of locating, applicable to the scenario of periodical locating).

After a locating request message is received, if the WiMAX terminal is in the idle or sleep state currently, the serving ASN-GW performs state conversion with the WiMAX terminal first, and sends a state transition message to the WiMAX terminal. The WiMAX terminal responds to the state transition message, and transitions from the idle or sleep state to the active state.

If the locating method based on the BSID of the S-BS is applied, the serving ASN-GW may return the BSID to the CSN or LCS server directly, and then the process is ended.

The BSID-based locating method mentioned above is a locating mode which determines the user location according to the BSID of the S-BS (namely, the BS that provides services for the WiMAX terminal currently). Each BSID uniquely identifies a BS, and the area corresponding to the BS is obtained by querying the geographic location information database after the BSID is obtained.

Detailed below is an embodiment in which the entity capable of calculating locating information is a serving ASN-GW. The BSID-based locating method is known in the art, and is not detailed here.

FIG. 6 is a flowchart of a method in an embodiment of the present disclosure. This embodiment supposes that the WiMAX terminal is a Mobile Station (MS) in the idle state, and the MS is located through the locating method based on the RTD of multiple BSs. The method includes the following steps.

Step 601: The serving ASN-GW receives an authenticated request of locating an MS from a CSN or LCS server.

The locating request includes but is not limited to the following contents: identifier of the locating request sender, identifier of the located terminal, locating type, time of sending the locating request, locating method, requested QoS parameters (for example, locating precision, response time, and requested locating QoS level) of the LCS, mode of reporting the locating result, and periodical locating information (frequency, count or total time of locating, applicable to the scenario of periodical locating).

Step 602: The serving ASN-GW sends a state transition message to the MS in the idle state, and the MS responds to the message.

The state transition message is a paging instruction. After receiving the paging instruction, the MS transitions from the idle state to the active state so as to assist the BS in measuring the locating data required for the locating calculation in the subsequent process.

Step 603: According to the requirement of the locating request and the locating capability of the current network and the MS, the serving ASN-GW decides to apply the locating method based on multiple RTDs, and sends a measurement request message to the S-BS. The measurement request message specifies the data that needs to be measured for the LCS. The data includes but is not limited to: radio RTD, RD, serving BSID, neighboring cell BSID, CINR, RSSI, and radio signal measurement result of the N-BS. The serving ASN-GW notifies the S-BS to send a mobile scan response (MOB_SCN-RSP) message to the MS.

In this step, the RTD measurement request message may further carry an N-BS list of the S-BS specified by the serving ASN-GW.

Step 604: The S-BS sends a MOB_SCN-RSP message to the MS, requiring the MS to scan the BS of the neighboring cell.

Step 605: The MS scans the S-BS and the N-BS, and obtains the RTD between the MS, the S-BS, and the N-BS.

Step 606: Upon completion of scanning, the MS sends a MOB_SCN-REP message to the S-BS, reporting the measurement result to the S-BS.

Step 607: The S-BS sends an RTD measurement response to the serving ASN-GW, further reporting the measurement result to the serving ASN-GW.

Step 608: According to the QoS requirement and measurement result carried in the locating measurement message, the serving ASN-GW calculates the location information of the MS, and reports the calculation result to the CSN or LCS server.

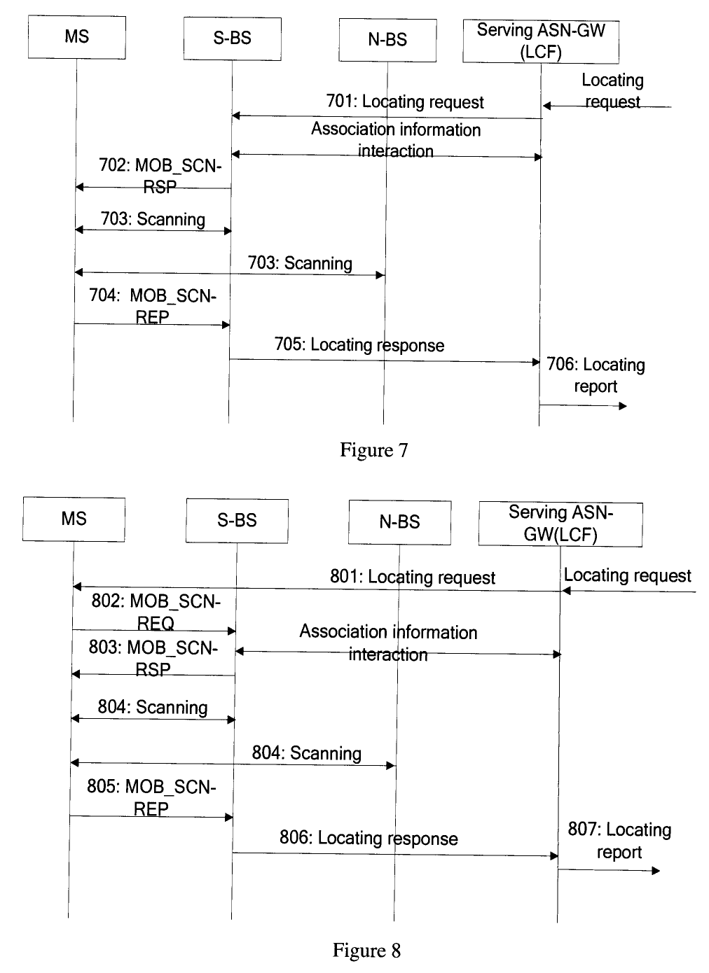

FIG. 7 is a flowchart of a method according to another embodiment of the present disclosure, where the MS is located through a hyperbola-based locating method. Compared with the locating method based on the RTD of multiple BSs in some embodiments, the process in this embodiment is almost the same, and also requires the MS, the S-BS, and the N-BS to perform scanning. However, this locating method requires scanning with at least two N-BSs. As shown in FIG. 7, the locating method includes the following steps:

Step 701: The serving ASN-GW receives the locating request message from the LCS server.

The locating request message includes but is not limited to the following contents: identifier of the locating request sender, identifier of the located terminal, locating type, time of sending the locating request, locating method, requested QoS parameters (for example, locating precision, response time, and requested locating QoS level) of the LCS, mode of reporting the locating result, and periodical locating information (frequency, count or total time of locating, applicable to the scenario of periodical locating).

According to the QoS requirement of the locating request and the locating capability of the current network and the MS, the serving ASN-GW decides to apply the hyperbola-based locating method, and sends a locating data measurement request to the S-BS. The locating data measurement request specifies the data that needs to be measured for the LCS. The data includes but is not limited to: radio RTD, RD, serving BSID, neighboring cell BSID, CINR, RSSI, and radio signal measurement result of the N-BS. The serving ASN-GW may specify the N-BS list of the S-BS in the request.

Step 702: The S-BS sends a MOB_SCN-RSP message to the MS, triggering the MS to perform downlink data synchronization and detection of the N-BS.

The MOB_SCN-RSP message may carry an LCS locating scan indication. Before scanning, an association process may be performed, depending on the actual conditions.

Step 703: The MS scans the S-BS and at least two N-BSs, and obtains the RD and RTD values.

If the MOB_SCN-RSP message carries an LCS locating indication, the MS may scan according to the N-BS recommended in the received MOB_SCN-RSP message; otherwise, the MS selects an N-BS for scanning according to the actual conditions of the MS only if at least two N-BSs are scanned.

Step 704: The MS sends a MOB_SCN-REP message to the S-BS, reporting the measurement result to the S-BS.

Step 705: After receiving the measurement result, the S-BS sends a locating response to the serving ASN-GW, further reporting the measurement result to the serving ASN-GW.

As required, encryption protection is performed for the message interaction between entities.

Step 706: According to the measurement result, the serving ASN-GW calculates the locating information, and reports the calculated locating information to the LCS server.

FIG. 8 is a flowchart of a method according to another embodiment of the present disclosure, where the MS is also located through a hyperbola-based locating method. Compared with the locating method based in some embodiments, this embodiment adds an L3 message between the serving ASN-GW and the MS to send a locating request. As shown in FIG. 8, the method includes the following steps:

Step 801: The serving ASN-GW receives the locating request message from the LCS server.

The locating request message includes but is not limited to the following contents: identifier of the locating request sender, identifier of the located terminal, locating type, time of sending the locating request, locating method, requested QoS parameters (for example, locating precision, response time, and requested locating QoS level) of the LCS, mode of reporting the locating result, and periodical locating information (frequency, count or total time of locating, applicable to the scenario of periodical locating).

According to the information such as QoS in the locating request, the serving ASN-GW selects the hyperbola-based locating method to locate the MS, and sends a locating request to the MS through an Intermittence Spectral Frequency (ISF) message.

In this step, through an ISF service flow, the serving ASN-GW sends a locating request message to the MS. The locating request message specifies the data that needs to be measured for the LCS. The data includes but is not limited to: radio RTD, RD, serving BSID, neighboring cell BSID, CINR, RSSI, and radio signal measurement result of the N-BS. The message may carry an N-BS list of the S-BS specified by the serving ASN-GW.

Step 802: To obtain certain collaboration from the network, the MS needs to send a mobile scan request (MOB_SCN-REQ) message to the S-BS, and the message may carry an LCS locating scan indication. This step is optional.

Step 803: The S-BS sends a MOB_SCN-RSP message to the MS, triggering the MS to perform downlink data synchronization and detection of the N-BS.

The message may carry an LCS locating scan indication.

Step 804: The MS scans the S-BS and at least two N-BSs, and obtains the RD and RTD values.

If the MOB_SCN-RSP message carries an LCS locating indication, the MS may scan according to the N-BS recommended in the received MOB_SCN-RSP message; otherwise, the MS selects an N-BS for scanning according to the actual conditions of the MS only if at least two N-BSs are scanned.

Step 805: The MS sends a MOB_SCN-REP message to the S-BS, reporting the measurement result to the S-BS. This step is optional.

Step 806: The MS sends a locating response to the serving ASN-GW, further reporting the measurement result to the serving ASN-GW.

The locating response may be sent through an ISF service flow. As required, encryption protection is performed for the message interaction between entities.

Step 807: According to the measurement result, the serving ASN-GW calculates the locating information, and reports the calculated locating information to the LCS server.

Based on the foregoing method, a locating data measurement entity is provided in an embodiment of the present disclosure. The locating data measurement entity is adapted to: receive the locating request from the LCF, perform locating data measurement according to the locating request, and send the obtained locating data measurement result to the calculation entity.

A LCF entity provided in this embodiment is adapted to: send locating measurement information to the locating data measurement entity, and receive the locating information from the calculation entity and output the locating information. Optionally, the LCF entity is adapted to: send locating measurement information to the locating data measurement entity, and calculate the locating information according to the locating data measurement result returned by the locating data measurement entity and output the locating information. The LCF entity is located in the serving ASN-GW, or acts as an independent function entity.

A calculation entity provided in this embodiment is adapted to: receive the locating data measurement result from the locating data measurement entity, calculate the locating information according to the locating data measurement result, and send the locating information to the LCF. The calculation entity is located in the LCF of the serving ASN-GW, the S-BS or WiMAX terminal.

Based on the foregoing entity, the system under the present disclosure includes:

an LCF entity adapted to send locating measurement information to the locating data measurement entity, and receive the locating information from the calculation entity and output the locating information;

a locating data measurement entity adapted to receive the locating request from the LCF, perform locating data measurement according to the locating request, and send the obtained locating data measurement result to the calculation entity; and

a calculation entity adapted to receive the locating data measurement result from the locating data measurement entity, calculate the locating information according to the locating data measurement result, and send the locating information to the LCF.

The system further includes:

an N-BS adapted to perform information interaction with the locating data measurement entity while the locating data measurement entity measures the locating data, and provide locating data information for the locating data measurement entity; and an S-BS adapted to perform information interaction with the locating data measurement entity while the locating data measurement entity measures the locating data, provide locating data information for the locating data measurement entity, and forward messages during information interaction between the locating data measurement entity and the LCF.

The foregoing LCF is located in a serving ASN-GW or an independent function entity, the locating data measurement entity is located in the WiMAX terminal, and the calculation entity is located in the LCF of the serving ASN-GW, WiMAX terminal, or S-BS. If the calculation entity is located in the LCF, the functions of the LCF in the system are to: send locating measurement information to the locating data measurement entity, and calculate the locating information according to the locating data measurement result returned by the locating data measurement entity and output the locating information.

The LCF itself is capable of calculating. The foregoing calculation entity located in the LCF implies that the LCF implements the calculation function in the system. However, even if the calculation function of the system is performed by another device such as a WiMAX terminal, the calculation function of the LCF is also existent but not active because another device in the calculation entity of the system provides and performs the calculation function.

The serving ASN-GW further includes a state transition instruction generating module, and the WiMAX terminal further includes a state transition module.

The state transition instruction generating module is adapted to send a state transition message to the state transition module.

The state transition module is adapted to receive the state transition message from the state transition instruction generating module, and change its own state from the idle or sleep state to the active state according to the state transition message.

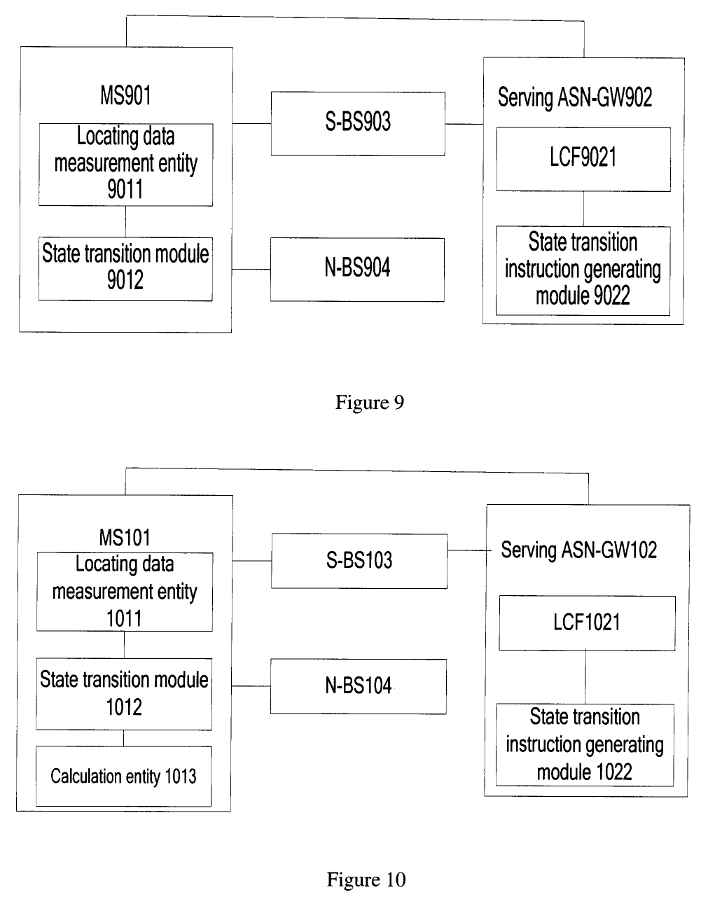

FIG. 9 shows a structure of a system according to an embodiment of the present disclosure. In this embodiment, the WiMAX terminal is an MS. As shown in FIG. 9, the system includes a serving ASN-GW 902 and an MS 901. The serving ASN-GW 902 includes a LCF 9021, and a state transition instruction generating module 9022. The MS 901 includes a locating data measurement entity 9011 and a state transition module 9012.

The LCF 9021 is adapted to send locating measurement information to the locating data measurement entity 9011, and calculate the locating information according to the locating data measurement result returned by the locating data measurement entity 9011 and output the locating information.

The locating data measurement entity 9011 is adapted to receive the locating request from the LCF 9021, perform locating data measurement according to the locating request, and send the locating data measurement result to the LCF 9021.

The state transition instruction generating module 9022 is adapted to send a state transition message to the state transition module 9012.

The state transition module 9012 is adapted to: receive the state transition message from the state transition instruction generating module 9022, and change its own state from the idle or sleep state to the active state according to the state transition message.

The system further includes:

an N-BS 904 adapted to perform information interaction with the locating data measurement entity 9011 while the locating data measurement entity 9011 measures the locating data, and provide locating data information for the locating data measurement entity 9011; and an N-BS 903 adapted to perform information interaction with the locating data measurement entity 9011 while the locating data measurement entity 9011 measures the locating data, provide locating data information for the locating data measurement entity 9011, and forward information during information interaction between the locating data measurement entity 9011 and the LCF 9021. Forwarding of information includes: receiving the locating request from the LCF 9021, and sending a locating request to the locating data measurement entity 9011; and receiving the locating data measurement result from the locating data measurement entity 9011, and sending the locating data measurement result to the LCF 9021 in the case of returning the locating data measurement result.

If the locating mode based on multiple BSIDs is applied, the locating data measurement entity 9011 is specifically adapted to receive the locating request from the LCF 9021, and measure the signal strength of the N-BS 904 according to the locating request; and return the BSID of the N-BS 904 to the LCF 9021, if the signal strength reaches a preset threshold. In this case, the LCF 9021 is specifically adapted to: send locating measurement information to the locating data measurement entity 9011, obtain the information about the coverage area of each BS according to the BSID returned by the locating data measurement entity 9011, calculate the intersection of the coverage areas of all BSs, and output the calculated intersection.

If the RTD-based locating mode is applied, the locating data measurement entity 9011 is specifically adapted to receive the locating request from the LCF 9021, and scan the S-BS 903 and the N-BS 904 according to the locating request in order to obtain the RTD value. In this case, the LCF 9021 is specifically adapted to send locating measurement information to the locating data measurement entity 9011, and calculate the intersection of the location areas defined by the RTD values according to the RTD value returned by the locating data measurement entity 9011.

If the hyperbola-based locating mode is applied, the locating data measurement entity 9011 is specifically adapted to receive the locating request from the LCF 9021, and scan the S-BS 903 and two or more N-BSs 904 according to the locating request in order to obtain the RD value. In this case, the LCF 9021 is specifically adapted to send locating measurement information to the locating data measurement entity 9011, and calculate the intersection of the hyperbolas defined by the RD values according to the RD value returned by the locating data measurement entity 9011, where the intersection is the desired locating information, namely, the found location in this embodiment.

FIG. 10 shows a structure of a system in another embodiment of the present disclosure. In this embodiment, the WiMAX terminal is also an MS. Compared with the first embodiment, the system in this embodiment differs only in that the calculation function is performed by the calculation entity in the MS rather than by the LCF. As shown in FIG. 10, the system includes a serving ASN-GW 102 and an MS 101. The serving ASN-GW 102 includes an LCF 1021 and a state transition instruction generating module 1022. The MS 101 includes a locating data measurement entity 1011, a state transition module 1012, and a calculation entity 1013.

The LCF 1021 is adapted to send locating measurement information to the locating data measurement entity 1011, and receive the locating information from the calculation entity 1013 and output the locating information.

The locating data measurement entity 1011 is adapted to receive the locating request from the LCF 1021, perform locating data measurement according to the locating request, and send the obtained locating data measurement result to the calculation entity 1013.

The calculation entity 1013 is adapted to receive the locating data measurement result from the locating data measurement entity 1011, calculate the locating information according to the locating data measurement result, and send the locating information to the LCF 1021.

The state transition instruction generating module 1022 is adapted to send a state transition message to the state transition module 1012.

The state transition module 1012 is adapted to receive the state transition message from the state transition instruction generating module 1022, and change its own state from the idle or sleep state to the active state according to the state transition message.

The system further includes:

an N-BS 104 adapted to perform information interaction with the locating data measurement entity 1011 while the locating data measurement entity 1011 measures the locating data, and provide locating data information for the locating data measurement entity 1011; and

an S-BS 103 adapted to perform information interaction with the locating data measurement entity 1011 while the locating data measurement entity 1011 measures the locating data, and provide locating data information for the locating data measurement entity 1011, and forward information during information interaction between the locating data measurement entity 1011 and the LCF 1021. Forwarding of the information includes: receiving the locating request from the LCF 1021, and forwarding the locating request to the locating data measurement entity 1011.

If the locating mode based on multiple BSIDs is applied, the locating data measurement entity 1011 is specifically adapted to: receive the locating request from the LCF 1021, and measure the signal strength of the N-BS 104 according to the locating request; and send the BSID of the N-BS 104 to the calculation entity 1013, if the signal strength reaches a preset threshold. In this case, the calculation entity 1013 is specifically adapted to receive the BSID from the locating data measurement entity 1011, obtain the information about the coverage area of each BS according to the BSID, calculate the intersection of the coverage areas of all BSs, and output the intersection to the LCF 1021.

If the RTD-based locating mode is applied, the locating data measurement entity 1011 is specifically adapted to receive the locating request from the LCF 1021, and scan the S-BS 103 and the N-BS 104 according to the locating request in order to obtain the RTD value. In this case, the calculation entity 1013 is specifically adapted to receive the RTD value from the locating data measurement entity 1011, calculate the intersection of the location areas defined by the RTD values, and output the intersection to the LCF 1021.

If the hyperbola-based locating mode is applied, the locating data measurement entity 1011 is specifically adapted to receive the locating request from the LCF 1021, and scan the S-BS 103 and two or more N-BSs 104 according to the locating request in order to obtain the RD value. In this case, the calculation entity 1013 is specifically adapted to receive the RD value from the locating data measurement entity 1011, calculate the intersection of the hyperbolas defined by the RD values, and output the intersection to the LCF 1021.

Therefore, according to some embodiments of the present disclosure, the LCS is provided for the WiMAX terminal in the WiMAX network in a manner which may be easily practicable and quickly responsive, and ensures precision and accuracy of locating.

Although the disclosure has been described through several embodiments, the disclosure is not limited to such embodiments. It is apparent that those skilled in the art can make various modifications and variations to the disclosure without departing from the spirit and scope of the disclosure. The disclosure is intended to cover the modifications and variations provided that they fall in the scope of protection defined by the claims or their equivalents.

What is claimed is:

1. A locating method, comprising:
sending, by a Locating Control Function (LCF) entity, a locating request, obtaining a locating data measurement result, and sending the locating data measurement result to an entity capable of calculating locating information; and
calculating, by the entity capable of calculating locating information, the locating information according to the locating data measurement result.

2. The locating method of claim 1, wherein if the LCF entity is located in a serving Access Service Network Gateway (ASN-GW) the sending the locating request from the LCF entity comprises:
sending, by the serving ASN-GW, locating measurement information to a Worldwide Interoperability for Microwave Access (WiMAX) terminal; or
sending, by the serving ASN-GW, the locating measurement information to a Serving Base Station (S-BS) and sending, by the S-BS, the locating measurement information to the WiMAX terminal.

3. The locating method of claim 1, wherein if the LCF entity is independent of a serving Access Service Network Gateway (ASN-GW) the sending the locating request from the LCF entity comprises:
sending, by the LCF entity, locating measurement information to the serving ASN-GW;
forwarding, by the serving ASN-GW, the locating measurement information to a Worldwide Interoperability for Microwave Access (WiMAX) terminal; or
sending, by the LCF entity, the locating measurement information to the serving ASN-GW;
sending, by the serving ASN-GW, the locating measurement information to a Serving Base Station (S-BS); and forwarding, by the S-BS, the locating measurement information to the WiMAX terminal.

4. The locating method of claim 2, wherein the locating measurement information comprises at least one of the following: radio Round Trip Delay (RTD); Relative Delay (RD); serving Base Station Identifier (BSID); neighboring cell BSID; Carrier-to-Interference and Noise Ratio (CINR);
Received Signal Strength Indicator (RSSI); and radio signal measurement result of Neighboring cell Base Station (N-BS).

5. The locating method of claim 2, wherein
before the serving ASN-GW sends the locating measurement information to the WiMAX terminal, the method further comprises:
receiving, by the serving ASN-GW, a locating request message from a Connection Service Network (CSN) or a Locating Service (LCS) server; and
sending, by the serving ASN-GW, a state transition message to the WiMAX terminal, if the WiMAX terminal is in an idle or sleep state; responding, by the WiMAX terminal, to the state transition message, and changing from the idle or sleep state to an active state;
or,
before the serving ASN-GW sends the locating measurement information to the S-BS, the method further comprises:
receiving, by the serving ASN-GW, the locating request message from the CSN, or the LCS server; and
sending, by the serving ASN-GW, the state transition message to the WiMAX terminal, if the WiMAX terminal is in the idle or sleep state; responding, by the WiMAX terminal, to the state transition message, and changing from the idle or sleep state to the active state.

6. The locating method of claim 5, wherein the locating request message comprises at least one of the following: identifier of a locating request sender; identifier of a located terminal; locating type; time of sending the locating request; locating method; requested Quality of Service (QoS) parameters of the LCS; mode of reporting a locating result; and periodical locating information.

7. The locating method of claim 2, wherein:
the obtaining the locating data measurement result by the LCF entity comprises:
measuring, by the WiMAX terminal, signal strength of more than one Neighboring cell BS (N-BS); and
sending a Base Station Identifier (BSID) of the N-BS to the entity capable of calculating the locating information, if the signal strength reaches a preset threshold;
the calculating the locating information according to the locating data measurement result by the entity capable of calculating the locating information comprises:
obtaining, by the entity capable of calculating the locating information, information about coverage areas of each Base Station, (BS) according to the BSID; and
calculating an intersection of the coverage areas of all BSs.

8. The locating method of claim 2, wherein:
the obtaining the locating data measurement result by the LCF entity comprises:
scanning, by the WiMAX terminal, the S-BS or both the S-BS and a Neighboring cell Base Station (N-BS); and
obtaining a radio signal Round Trip Delay (RTD) value between the WiMAX terminal, the S-BS, and the N-BS; and
the calculating the locating information according to the locating data measurement result by the entity capable of calculating the locating information comprises:
determining, by the entity capable of calculating the locating information, a location area or an intersection of location areas according to the radio signal RTD value of the S-BS.

9. The locating method of claim 2, wherein:
the obtaining the locating data measurement result by the LCF entity comprises:
scanning, by the WiMAX terminal, the S-BS or both the S-BS and two or more Neighboring cell Base Stations (N-BS); and
obtaining a downlink signal transmission time difference value, namely, a Relative Delay (RD) value, between the S-BS and the N-BS; and
the calculating the locating information according to the locating data measurement result by the entity capable of calculating the locating information comprises:
determining, by the entity capable of calculating the locating information, an intersection of hyperbolas according to the RD value.

10. The locating method of claim 9, wherein:
the obtaining the locating data measurement result by the LCF entity further comprises:
scanning, by the WiMAX terminal, the S-BS and the two or more N-BSs; and
obtaining a radio signal Round Trip Delay (RTD) value between the WiMAX terminal, the S-BS, and the N-BSs;
the calculating the locating information according to the locating data measurement result by the entity capable of calculating the locating information further comprises:
determining, by the entity capable of calculating the locating information, the intersection of the hyperbolas according to the RD value and the radio signal RTD value.

11. The locating method of claim 10, wherein:
if the locating measurement information carries a locating scan indication when the WiMAX terminal scans the N-BS, the WiMAX terminal scans a specified N-BS according to the locating scan indication.

12. The locating method of claim 2, wherein:
the sending the locating data measurement result from the LCF entity to the entity capable of calculating the locating information comprises:
sending, by the WiMAX terminal, the locating data measurement result to the entity capable of calculating the locating information directly; or
sending, by the WiMAX terminal, the locating data measurement result to the S-BS; and
forwarding, by the S-BS, the locating data measurement result to the entity capable of calculating the locating information.

13. The locating method of claim 1, wherein:
the entity capable of calculating the locating information is a Worldwide Interoperability for Microwave Access, WiMAX, terminal; or a serving Access Service Network Gateway (ASN-GW);
or a serving Base Station (BS).

14. A locating system, comprising:
a Locating Control Function (LCF) entity, adapted to send a locating request to a locating data measurement entity, and receive locating information from a calculation entity and output the locating information;
the locating data measurement entity adapted to: receive a locating request from the LCF entity, perform locating data measurement according to the locating request, and send an obtained locating data measurement result to the calculation entity; and
the calculation entity adapted to receive the locating data measurement result from the locating data measurement entity, calculate the locating information according to the locating data measurement result, and send the locating information to the LCF entity.

15. The locating system of claim 14, further comprising:
a Neighboring cell Base Station (N-BS) adapted to perform information interaction with the locating data measurement entity while the locating data measurement entity measures locating data, and provide locating data information for the locating data measurement entity; and
a Serving Base Station (S-BS) adapted to perform the information interaction with the locating data measurement entity while the locating data measurement entity measures the locating data, and provide the locating data information for the locating data measurement entity; and/or forward messages during the information interaction between the locating data measurement entity and the LCF entity.

16. The locating system of claim 15, wherein:
the locating data measurement entity is specifically adapted to receive the locating request from the LCF entity; measure signal strength of the N-BS according to the locating request; and
send a Base Station Identifier (BSID) of the N-BS to the calculation entity if the signal strength reaches a preset threshold; and
the calculation entity is specifically adapted to receive the BSID from the locating data measurement entity, obtain information about a coverage area of each Base Station (BS) according to the BSID, calculate an intersection of coverage areas of all BSs, and output the intersection to the LCF entity; or,
the locating data measurement entity is specifically adapted to receive the locating request from the LCF entity, and scan the S-BS or the N-BS according to the locating request to obtain a radio signal Round Trip Delay (RTD) value; and
the calculation entity is specifically adapted to receive the radio signal RTD value from the locating data measurement entity, calculate an intersection of location areas defined by radio signal RTD values, and output the intersection to the LCF entity; or,
the locating data measurement entity is specifically adapted to receive the locating request from the LCF entity, and scan the S-BS and two or more N-BSs according to the locating request to obtain a downlink signal transmission time difference value, namely, a Relative Delay, RD, value; and
the calculation entity is specifically adapted to receive the RD value from the locating data measurement entity, calculate an intersection of hyperbolas defined by the RD values, and output the intersection to the LCF entity.

17. The locating system of claim 14, wherein:
the LCF entity is located in or independent of a serving Access Service Network Gateway (ASN-GW).

18. The locating system of claim 14, wherein:
the locating data measurement entity is located in a Worldwide Interoperability for Microwave
Access (WiMAX) terminal.

19. The locating system of claim 14, wherein:
the calculation entity is located in a Worldwide Interoperability for Microwave Access (WiMAX) terminal; or in a Serving Base Station (S-BS) or in the LCF entity.

20. A terminal, comprising:
a locating data measurement entity adapted to receive a locating request from a LCF entity, perform locating data measurement according to the locating request, and send an obtained locating data measurement result to a calculation entity; and
the calculation entity adapted to receive the locating data measurement result from the locating data measurement entity, calculate the locating information according to the locating data measurement result, and send the locating information to the LCF entity.
